(19) United States
(12) Patent Application Publication
(10) Pub. No.: US 2009/0007635 A1
(43) Pub. Date: Jan. 8, 2009

(54) Floating Bubble Jar Gas Dryer for Mud Gas Analyzer

(76) Inventor: Konstandinos Zamfes, Calgary (CA)

Correspondence Address: DIEDERIKS & WHITELAW, PLC, 12471 DILLINGHAM SQUARE, #301, WOODBRIDGE, VA, 22192, US

(21) Appl. No.: 12/144,040

(22) Filed: Jun. 23, 2008

Related U.S. Application Data
(60) Provisional application No. 60/929,355, filed on Jun. 22, 2007.

(51) Int. Cl. B01D 19/00; G01N 25/00

(52) U.S. Cl. 73/25.01; 96/172

(57) ABSTRACT

Floating bubble jar gas dryer include a container floating in glycol on top of input gas sample pipe. The gas flow pressure regulates the depth of sinking of the floating container in the drying liquid (glycol for water). Small holes at the bottom of the floating container disperse the gas into the liquid where the diffusion process absorbs the moisture from the gas sample.

### CROSS REFERENCE TO RELATED APPLICATIONS

This application claims the benefit of priority of U.S. Provisional Patent Application No. 60/929,355 filed Jun. 22, 2007, which is incorporated herein by reference in its entirety.

### FIELD OF THE INVENTION

The present invention relates generally to gas analysis. More particularly, the present invention relates to drying of a gas for analysis.

### BACKGROUND OF THE INVENTION

During the drilling of a well, mud is circulated down hole to carry away drilling cuttings. On the surface the mud is pumped through a gas trap and a gas sample collected. The gas sample collected passes through what is known as a bubble jar where a liquid desiccant, such as a glycol absorbs moisture from the gas sample, thus drying the gas sample before it is sent to a gas analyzer.

Conventional bubble jars utilize a liquid container and an input tube lowered through the liquid desiccant to the bottom of the liquid container. An output tube is placed at the top of the liquid container. As moisture is absorbed from the gas sample, the level of desiccant rises, and if the bubble jar becomes overfilled, the liquid, absorbed from the sample, may pass through the output tube into the gas analyzer, causing false readings and/or damage to expensive equipment, such as the gas analyzer.

### SUMMARY OF THE INVENTION

The invention relates apparatus and method for a floating bubble jar dryer, which includes a container floating in the liquid desiccant (for example glycol) on top of the input gas sample pipe. The gas flow pressure regulates the depth of the float in the drying liquid (for example glycol for water). Small holes at the bottom of the floating container disperse the gas in to the liquid where a diffusion process is absorbing the moisture from the gas sample.

The bubble jar dryer of the present invention provides increased protection for gas analyzer, with reduced maintenance and monitoring, both in frequency and degree of maintenance and monitoring, and may allow configurations which are smaller and lighter.

In one aspect, the present invention provides a bubble jar dryer for drying a gas stream, including a first drying section adapted to receive an initial level of liquid desiccant, an inlet adapted to receive the gas stream into the first drying section, a standpipe associated with the inlet, the standpipe adapted to extend above the initial level of liquid desiccant, a floating container movably received on the standpipe, the floating container having an interior and an exterior and an upper section and a lower section, and at least one passage between the interior and the exterior in the lower section, and an inlet adapted to direct the gas stream out of the first drying section, wherein the level of liquid desiccant rises as moisture is absorbed from the gas stream, and the floating container is adapted to at least partially float in proportion to the level of liquid desiccant.

In a further aspect, the present invention provides a method for drying a gas stream including providing the gas stream from an oil and gas well operation, providing a bubble jar dryer including a first drying section adapted to receive an initial level of liquid desiccant, an inlet adapted to receive the gas stream into the first drying section, a standpipe associated with the inlet, the standpipe adapted to extend above the initial level of liquid desiccant, a floating container moyably received on the standpipe, the floating container having an interior and an exterior and an upper section and a lower section, and at least one passage between the interior and the exterior in the lower section, and an inlet adapted to direct the gas stream out of the first drying section, wherein the level of liquid desiccant rises as moisture is absorbed from the gas stream, and the floating container is adapted to rise in proportion to the level of liquid desiccant, and passing the gas stream through the bubble jar dryer, analyzing the gas stream, and providing a log of gas stream analysis in correlation to the oil and gas well operation.

Other aspects and features of the present invention will become apparent to those skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a bubble jar of the present invention (with single drying section); and

FIG. 2 is a bubble jar of the present invention (with double drying section).

### DETAILED DESCRIPTION

The present invention provides an apparatus and process for at least partially removing moisture from a gas stream using a buoyant container and liquid desiccant for moisture absorption, for example a glycol to remove water from a gas stream.

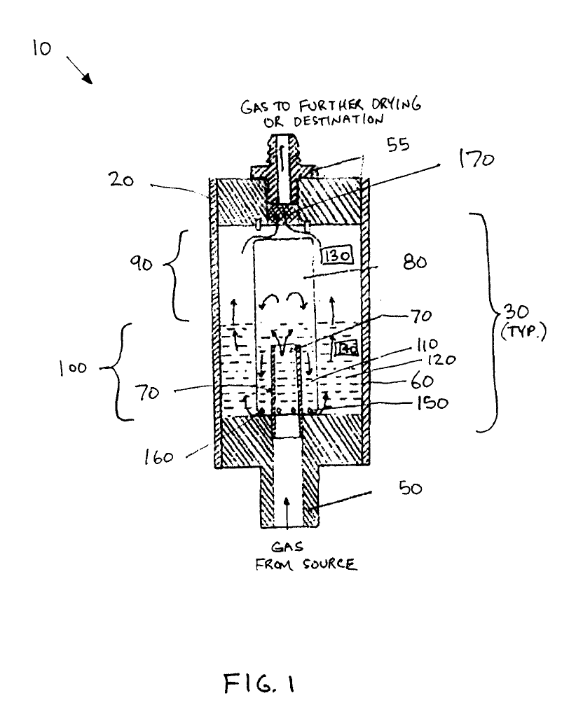

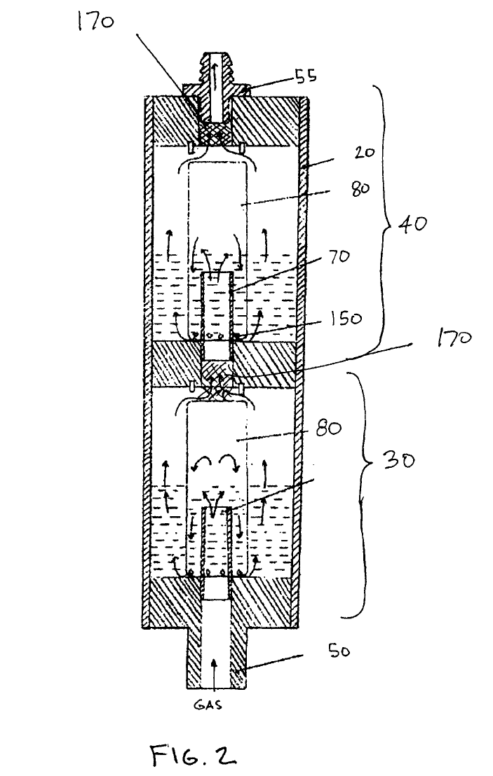

Referring to FIG. 1, a bubble jar 10 of the present invention includes a housing 20 having at least a first drying section 30. Preferably, as shown in FIG. 2, the bubble jar 10 also includes a second drying section 40, downstream of the first drying section 30.

The first drying section 30 includes an inlet 50 for receiving the gas to be dried and an outlet 55 for delivering the gas. A level of a liquid desiccant 60, for example a liquid glycol, for example ethylene glycol, is maintained within the first drying section 30. A standpipe 70 is operatively associated with the inlet 50 and within a floating container 80.

Preferably, the liquid desiccant 60 is a low vapour pressure, non-combustible liquid.

The floating container 80 has an upper section 90 and a lower section 100 and an interior 110 and an exterior 120. The upper section 90 forms a vapour space 130, above the level of the liquid desiccant 60 and the lower section 100 forms a liquid space 140, below the level of the liquid desiccant 60. At least one passage 150 extends between the interior 110 and the exterior 120 of the floating container 80, within the liquid desiccant 60. Preferably, the at least one passage 150 comprises a plurality of small holes 160.

In operation, the bubble jar 10 receives a source of gas to be sampled, for example from a turbine gas trap as described in U.S. Pat. No. 6,389,878 to Zamfes.

The gas to be sampled enters the bubble jar 10 from the inlet 50, moisture is removed in at least the first drying section 30 (and preferably moisture is removed in the second drying section 40), and the gas is directed to a gas analyzer for analysis, for example to a differential gas detector as described in U.S. Pat. No. 6,276,190 to Zamfes or a gas chromatograph or other gas analyzer.

Within the first drying section 30, the gas flows out the standpipe 70 into the floating container 80. The gas flows through the vapour space 130, through the liquid space 140, dispersed through the plurality of small holes 160 into the liquid desiccant 60, through the level of liquid desiccant 60, and out of the first drying section 30, in this preferred case, to the second drying section 40, where the process is repeated. The inlet 50 and/or the outlet 55 may include an orifice or valve or other control means to control or regulate the flow and/or pressure of the gas.

The gas analyzer (not shown, downstream of the outlet 55) may include a vacuum pump or other suction means to help draw the gas from the bubble jar 10.

A filter, media, membrane, mesh, or other device may be installed within the vapour space 130 to reduce the amount of fluid droplets (if any) carried or entrained in flow. Preferably, such a device is a knitted metallic or non-metallic (e.g. plastic) wire mesh entrainment separator 170 situated between the floating container 80 and the outlet 55.

A pressure differential across the bubble jar 10 will lift the floating container 80 to a level proportional to its weight and the level of the liquid desiccant 60 in the housing 20 and the pressure differential. If the level of the liquid desiccant 60 reaches the top of the standpipe 70 the floating container 80 will push the excess of liquid out into inlet 50. This will help improve performance of the bubble jar 10 and help reduce liquid overflow that can plug or otherwise damage the gas analyzer.

In the preceding description, for purposes of explanation, numerous details are set forth in order to provide a thorough understanding of the embodiments of the invention. However, it will be apparent to one skilled in the art that these specific details are not required in order to practice the invention.

The above-described embodiments of the invention are intended to be examples only. Alterations, modifications and variations can be effected to the particular embodiments by those of skill in the art without departing from the scope of the invention, which is defined solely by the claims appended hereto.

What is claimed is:

1. A bubble jar dryer for drying a gas stream, comprising:
a) a first drying section adapted to receive an initial level of liquid desiccant;
b) an inlet adapted to receive the gas stream into the first drying section;
c) a standpipe associated with the inlet, the standpipe adapted to extend above the initial level of liquid desiccant;
d) a floating container movably received on the standpipe, the floating container having an interior and an exterior and an upper section and a lower section, and at least one passage between the interior and the exterior in the lower section; and
e) an inlet adapted to direct the gas stream out of the first drying section, wherein the level of liquid desiccant rises as moisture is absorbed from the gas stream, and the floating container is adapted to at least partially float in proportion to the level of liquid desiccant.

2. The bubble jar dryer of claim 1, wherein the standpipe forms a weir, the weir adapted to overflow and allow the liquid to overflow out the inlet, when the level of the liquid desiccant exceeds the level of the weir.

3. The bubble jar dryer of claim 1, the liquid desiccant comprising a glycol.

4. The bubble jar dryer of claim 1, further comprising a second drying section.

5. The bubble jar dryer of claim 1, further comprising an entrainment separator

6. A method for drying a gas stream comprising:
a. providing the gas stream from an oil and gas well operation;
b. providing a bubble jar dryer comprising:
i. a first drying section adapted to receive an initial level of liquid desiccant;
ii. an inlet adapted to receive the gas stream into the first drying section;
iii. a standpipe associated with the inlet, the standpipe adapted to extend above the initial level of liquid desiccant;
iv. a floating container movably received on the standpipe, the floating container having an interior and an exterior and an upper section and a lower section, and at least one passage between the interior and the exterior in the lower section; and
v. an inlet adapted to direct the gas stream out of the first drying section,
vi. wherein the level of liquid desiccant rises as moisture is absorbed from the gas stream, and the floating container is adapted to rise in proportion to the level of liquid desiccant; and
c. passing the gas stream through the bubble jar dryer;
d. analyzing the gas stream; and
e. providing a log of gas stream analysis in correlation to the oil and gas well operation.

7. The method of claim 6, the oil and well gas operation comprising drilling an oil and gas well.

8. The method of claim 6, the gas stream provided from drilling cuttings.

9. The method of claim 6, further comprising logging at least one parameter relative to the oil and gas well operation and logging the at least one parameter relative to the gas stream analysis, and correlating the gas stream analysis and the oil and gas well operation based on the at least one parameter.

10. The method of claim 9, the at least one parameter comprising time.

11. The method of claim 9, the at least one parameter comprising drilling depth.
